(19) United States
(12) Patent Application Publication
(10) Pub. No.: US 2015/0286248 A1
(43) Pub. Date: Oct. 8, 2015

(54) BRACKET AND FLAT PANEL ELECTRONIC PRODUCT EMPLOYING THE BRACKET

(71) Applicant: APRICOTT LLC, Davenport, FL (US)

(72) Inventor: Ravish Sony, Davenport, FL (US)

(21) Appl. No.: 14/431,191

(22) PCT Filed: Oct. 19, 2012
(86) PCT No.: PCT/US12/61092

§ 371 Date: Mar. 25, 2015

(30) Foreign Application Priority Data
Aug. 23, 2012 (CN) 201210302802.9

(51) Int. Cl. G06F 1/16; F16M 11/10; F16M 11/38; E05D 3/12

(52) U.S. Cl. CPC G06F 1/166; E05D 3/12; F16M 11/10; F16M 11/38; G06F 1/1662; G06F 1/1637

(57) ABSTRACT

The present invention relates to an electronic product, and provides a bracket and a flat panel electronic product employing the bracket, wherein the bracket includes a fixing plate which may be connected to a case enclosing a flat panel electronic device, a supporting leg which may be fixed to the bottom of a keyboard, and a pivot arranged between the fixing plate and the supporting leg and connected to them, wherein the fixing plate and the supporting leg may rotate around the pivot separately. The bracket can support the flat panel electronic device and the keyboard simultaneously, the bracket and the keyboard may be operated separately, in this way it is convenient for the user, and the bracket has good applicability.

### TECHNICAL FIELD

The present invention relates to an electronic product, particularly to a bracket and a flat panel electronic product employing the bracket.

### BACKGROUND

Flat panel electronic devices such as IPAD, PDA and other tablets are more and more popular because of their advantage of light weight and portability. The flat panel electronic devices can be operated by means of a touch screen, but the touch screen is often used in the occasion of amusement, and the flat panel electronic device is operated by means of a keyboard in the formal occasion or the work occasion. When operated by a keyboard, the flat panel electronic device is typically supported by a bracket. The existing brackets can only support the flat panel electronic devices, but cannot be applied to the keyboards, meanwhile the keyboards are independent to the brackets, so it is inconvenient to carry them.

### SUMMARY

The aim of the present invention is to overcome the shortcoming of the products in prior art, to provide a bracket with simple structure and a flat panel electronic product employing the bracket.

The above-mentioned technical problems can be solved through the following technical solutions: a bracket including a fixing plate which may be connected to a case enclosing a flat panel electronic device, a supporting leg suitable for being fixed to the bottom of a keyboard, and a pivot arranged between the fixing plate and the supporting leg and connected to them, wherein the fixing plate and the supporting leg may rotate around the pivot separately.

Particularly, the supporting leg comprises a first supporting foot and a second supporting foot, wherein the first supporting foot includes two rotating arms arranged in parallel and rotatably connected to the ends of the pivot separately and a link arm arranged between the two rotating arms and connected to them; the second supporting foot has the shape of inverted T, the vertical part thereof being rotatably connected to the middle part of the pivot, the horizontal part thereof being positioned inside the link arm following rotation.

Furthermore, at least one projection is/are disposed at the outer surface of the link arm of the first supporting foot, wherein the projection (s) may be fastened with a keyboard.

Furthermore, there are a number of spaced protrusions disposed at the outer surface of the rotating arms of the first supporting foot.

Furthermore, there is a slot containing a movable press key in the vertical part of the second supporting foot, wherein a supporting shaft is arranged at the central part of the press key, the two ends of the supporting shaft are disposed in the slot, and the end thereof close to the pivot may be pressed down and the other end will go up.

Particularly, the fixing plate contains a supporting arm and a connecting part rotatably coupled with the supporting arm, wherein the supporting arm is rotatably coupled with the pivot, and there is a fastening on the connecting part for coupling with a case enclosing a flat panel electronic device and for the rotation thereof

Particularly, the fastening contains a round groove and a pair of elastic clasps arranged therein, wherein the elastic clasps may move inwardly.

The present invention also provides a flat panel electronic product comprising a flat panel electronic device, a keyboard, and a bracket including a fixing plate connected with a case enclosing the flat panel electronic device, a supporting leg fixed onto the bottom of the keyboard and a pivot arranged between the fixing plate and the supporting leg and connected to them, wherein the fixing plate and the supporting leg may rotate around the pivot separately.

Particularly, the supporting leg comprises a first supporting foot and a second supporting foot, wherein the first supporting foot includes two rotating arms arranged in parallel and rotatably connected to the ends of the pivot separately and a link arm arranged between the two rotating arms and connected to them; the second supporting foot has the shape of inverted T, the vertical part thereof being rotatably connected to the middle part of the pivot, the horizontal part thereof being positioned inside the link arm following rotation.

Furthermore, the bottom of the keyboard is provided with a sliding slot for the sliding of the first supporting foot, the link arm of the first supporting foot has at least one projection installed on the outer surface thereof, and the sliding slot is equipped with a moving shift block which has a clasp for locking the projection.

The bracket according to the present invention can support the flat panel electronic device and the keyboard simultaneously, and because the supporting leg and the keyboard can be connected together or be detached from each other, the bracket and the keyboard may be operated separately according to demand or occasion, in this way it is convenient for the user, and the bracket has good applicability.

### BRIEF DESCRIPTION OF THE DRAWINGS

FIG. 1 is a schematic view of a bracket according to a preferred embodiment of the present invention;

FIG. 2 is a first schematic view of a status of a bracket in a preferred embodiment of the invention;

FIG. 3 is a second schematic view of a status of a bracket in a preferred embodiment of the invention;

FIG. 4 is a third schematic view of a status of a bracket in a preferred embodiment of the invention;

FIG. 5 is a schematic view of a flat panel electronic product according to a preferred embodiment of the present invention;

FIG. 6 is a schematic view of the bottom of a flat panel electronic product after overturned according to a preferred embodiment of the invention;

FIG. 7 is a structural schematic view of the connection between the bottom of a keyboard and the first supporting foot of the invention;

FIG. 8 is a first structural schematic view of a bracket according to an embodiment of the invention for supporting the flat panel electronic device of a flat panel electronic product;

FIG. 9 is a second structural schematic view of a bracket according to an embodiment of the invention for supporting the flat panel electronic device of a flat panel electronic product;

FIG. 10 is a third structural schematic view of a bracket according to an embodiment of the invention for supporting the flat panel electronic device of a flat panel electronic product;

FIG. 11 is a fourth structural schematic view of a bracket according to an embodiment of the invention for supporting the flat panel electronic device of a flat panel electronic product;

FIG. 12 is a fifth structural schematic view of a bracket according to an embodiment of the invention for supporting the flat panel electronic device of a flat panel electronic product;

FIG. 13 is a sixth structural schematic view of a bracket according to an embodiment of the invention for supporting the flat panel electronic device of a flat panel electronic product;

FIG. 14 is a seventh structural schematic view of a bracket according to an embodiment of the invention for supporting the flat panel electronic device of a flat panel electronic product.

### DETAILED DESCRIPTION OF THE PREFERRED EMBODIMENTS

Objects, advantages and embodiments of the present invention will be explained below in detail with reference to the preferred embodiments and the accompanying drawings. However, it is to be appreciated that the following description of the embodiment(s) is merely exemplary in nature and is no way intended to limit the invention.

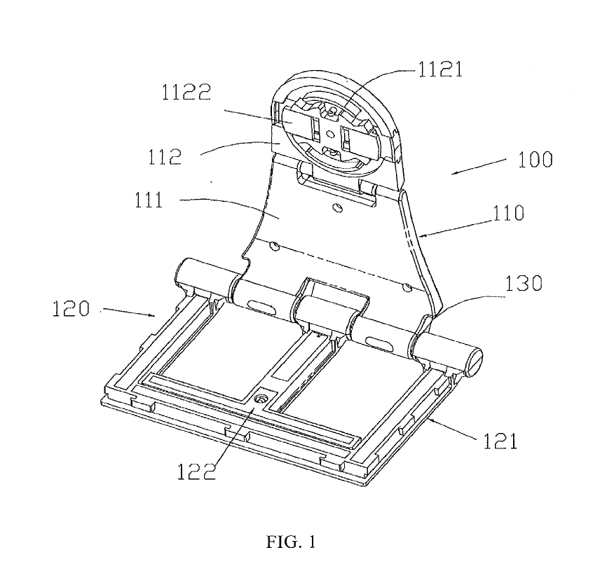

Referring to FIG. 1, a bracket 100 mainly applied to a flat panel electronic device is provided in this invention. The bracket 100 includes a fixing plate 110, a supporting leg 120 and a pivot 130 rotatably connecting the fixing plate 110 with the supporting leg 120 together. The fixing plate 110 may be connected to a case enclosing a flat panel electronic device, and the supporting leg may be fixed on the bottom of a keyboard by inserting and pulling or by means of magnetic connectors. In the present invention, the bracket applicable to a flat panel electronic device can support the flat panel electronic device and the keyboard simultaneously, and because the supporting leg and the keyboard can be connected together or be detached from each other, the bracket and the keyboard may be operated separately according to demand or occasion, in this way it is greatly convenient for the user, and the bracket has good applicability.

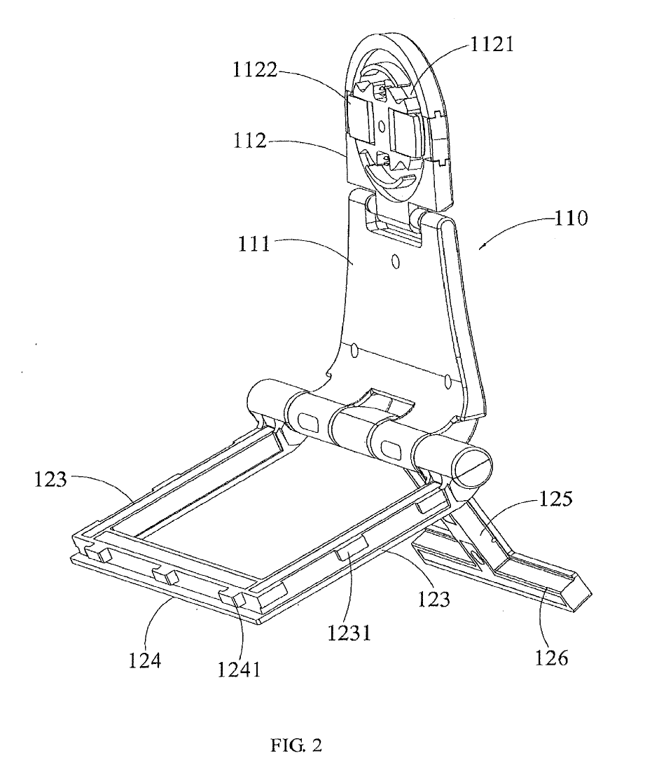

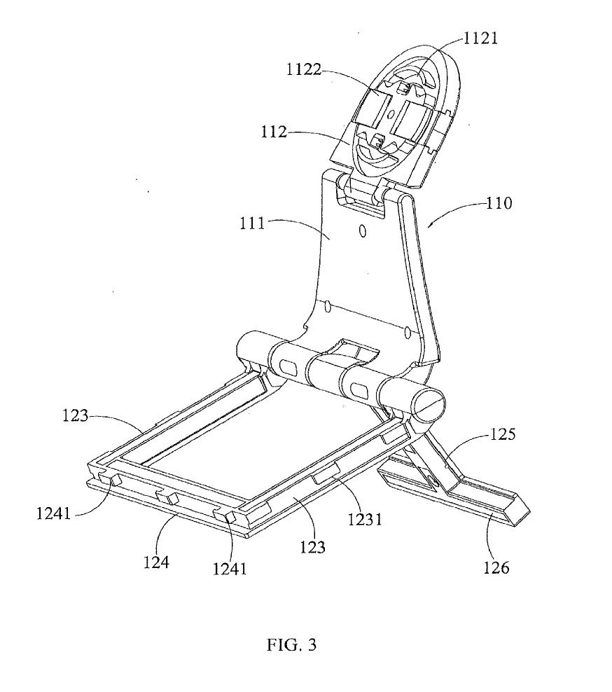

Particularly, referring to FIG. 2 and FIG. 3, the supporting leg 120 includes a first supporting foot 121 and a second supporting foot 122, both of them can move around the pivot 130 separately. As a result, the supporting angle between the first supporting foot and the second supporting foot may be adjusted by turning either of the supporting feet. The first supporting foot 121 includes two rotating arms 123 arranged in parallel and rotatably connected to the ends of the pivot 130 separately and a link arm 124 arranged between the two rotating arms 123 and connected thereto; the second supporting foot 122 has the shape of inverted T, the vertical part 125 thereof being rotatably connected to the middle part of the pivot 130, the horizontal part 126 of the second supporting foot 122 is a movable supporting element used to stand on a loading surface e.g. desktop. The first supporting foot 121 and the second supporting foot 122 may move freely against each other, and the second supporting foot 122 may be positioned inside the first supporting foot 121 and barely touch it. The horizontal part 126 of the second supporting foot 122 may be positioned inside the link arm 124 of the first supporting foot 121 as the angle between the second supporting foot 122 and the first supporting foot 121 turns to zero.

Furthermore, in this embodiment, the link arm 124 of the first supporting foot 121 has at least one projection 1241 disposed on the outer surface for coupling with a keyboard (there are three projections in the FIGs). The first supporting foot 121 may be locked and fixed with a keyboard by inserting the projections 1241 into the keyboard, thus the first supporting foot 121 slipping out of the bottom of the keyboard when use is prevented.

Furthermore, the vertical part 125 of the second supporting foot 122 has a male mechanism thereon (not shown in FIGs) for inserting into a corresponding female mechanism of a keyboard, and the second supporting foot 122 can be coupled with a keyboard using the male-female mechanisms.

Furthermore, there are a number of spaced protrusions 1231 disposed on the outer surface of the two rotating arms 123 of the first supporting foot 121. As a result, the first supporting foot 121 will be coupled with the corresponding structures of the keyboard when inserted into the keyboard thus prevent slipping.

In another embodiment of the present invention, the projection(s) 1241 and the protrusion(s) 1231 are replaced with a number of magnetic connectors and the first supporting foot 121 may be connected to a keyboard by means of the magnetic connectors.

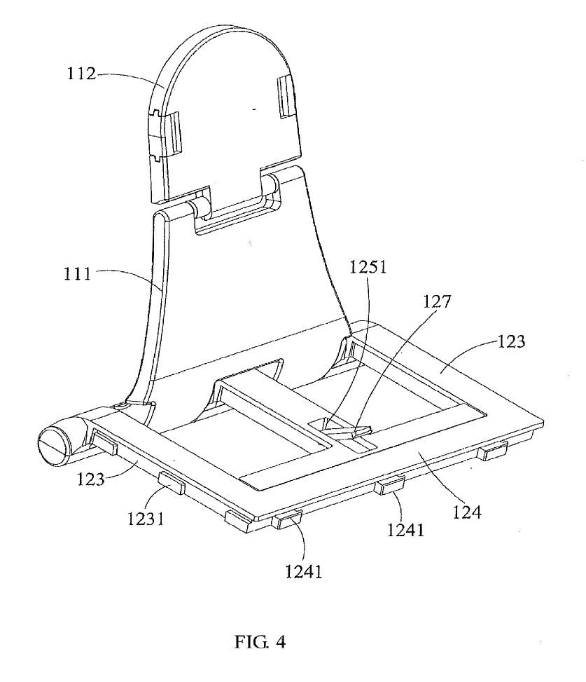

In this embodiment, referring to FIG. 4, there is a slot 1251 containing a movable press key 127 arranged in the vertical part 125 of the second supporting foot 122, wherein a supporting shaft is arranged at the central part of the press key 127 (not shown), the two ends of the supporting shaft are disposed in the slot 1251, and the two ends of the press key 127 may move around the supporting shaft. The end of the press key 127 close to the pivot 130 can be pressed down and the other end of the press key 127 will go up. The press key 127 is disposed in the slot 1251 in level, and when the second supporting foot 122 is to be moved from the inside of the first supporting foot 121, the end of the press key 127 close to the pivot can be pressed down into the slot 1251 thereby the other end goes up and the second supporting foot 122 can be pulled out.

In this embodiment, the fixing plate 110 includes a supporting arm 111 and a connecting part 112 rotatably coupled with the supporting arm 111, wherein the supporting arm 111 and the connecting part 112 are coupled via the pivot. Because there is friction force with the pivot, the connecting part 112 and the supporting arm 111 may be fixed at any angle, i.e. they have the function of self-locking. Similarly, the first supporting foot 121, the second supporting foot 122 and the pivot 130 can be disposed in the same way, they are fixed and self-locked at any angle. This kind of turning and self-locked structure is the same as that of the structure in the prior art, which is not detailed herein. There is a fastening for connecting with a case enclosing a flat panel electronic device on the connecting part 112, following coupling with the back via a case thereof the flat panel electronic device may rotate around the fastening Particularly, there are special cases with connecting parts on the back thereof for flat panel electronic devices e.g. IPAD and other tablets, wherein the connecting parts may be coupled with the fastening, which belong to the prior art and are not detailed herein. Referring to FIG. 1 and FIG. 2, in this embodiment, the fastening contains a round groove 1121 and a pair of elastic clasps 1122 arranged therein, wherein the elastic clasps will move inwardly when they are pressed simultaneously, thus the connecting part of the case may be coupled with the elastic clasps 1122, and the connecting part will be fixed onto the elastic clasps 1122 when let go the elastic clasps 1122. The elastic clasps 1122 may rotate around the round groove 1121, thus a user may watch the display of the flat panel electronic device in different angles.

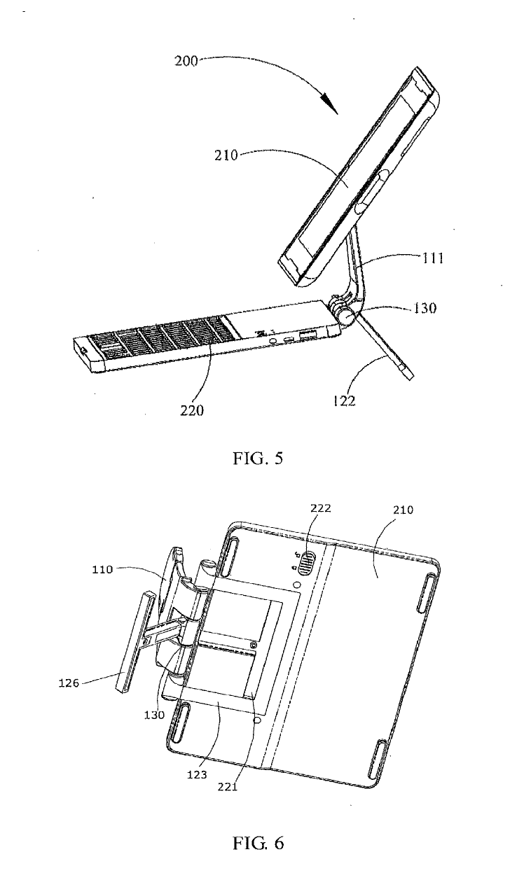

Referring to FIG. 5, it shows a flat panel electronic product 200 according to the invention. The flat panel electronic product 200 includes a flat panel electronic device 210 (such as an IPAD, PDA and other tablet) and a keyboard 220, and further includes the above-mentioned bracket 100, wherein the fixing plate 110 of the bracket 100 is fixed onto a case enclosing the flat panel electronic device, and the supporting leg 120 is connected to the bottom of the keyboard 220 by inserting and pulling or by means of magnetic connectors. Particularly, the first supporting foot 121 of the supporting leg 120 is inserted and fixed into the bottom of the keyboard 220, and the second supporting foot 122 can be detached from the keyboard and used to raise the keyboard and position the keyboard and the flat panel electronic device at various angles that may be comfortable to the user, while the first foot 121 remains being connected to the keyboard. The second supporting foot 122 is located inside the first supporting foot 121, and the outer structure of the first supporting foot 121 is not effected, so the first supporting foot 121 may still be connected to the bottom of the keyboard 220 by inserting and pulling when the angle between the second supporting foot 122 and the first supporting foot 121 is zero. Alternatively, the first supporting foot 121 of the supporting leg 120 may be coupled with the keyboard 220 by means of a number of magnetic connectors, and the second supporting foot 122 can be used to raise the keyboard and position the keyboard and the flat panel electronic device at various angles.

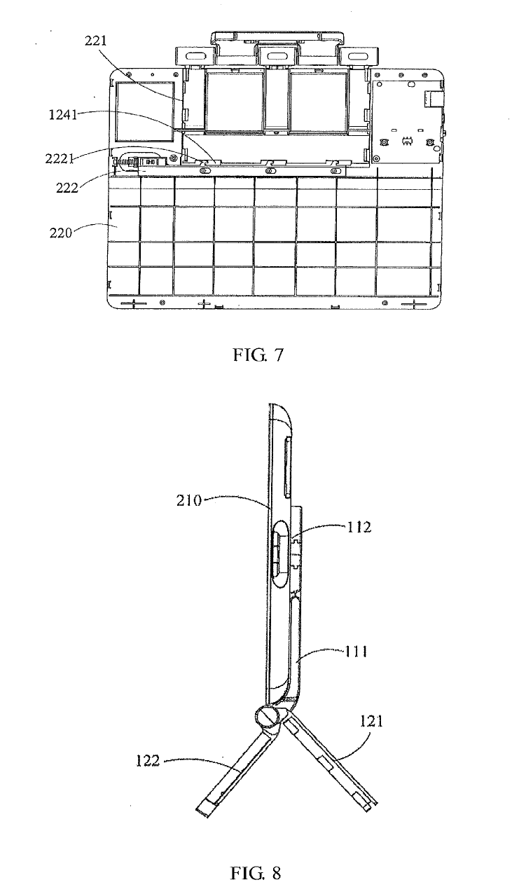

Particularly, referring to FIG. 6 and FIG. 7, the bottom of the keyboard 220 has a sliding slot 221 for the sliding of the first supporting foot 121, and a moving shift block 222 is arranged transversely in the inner surface of the sliding slot 221, the moving shift block 222 having a clasp 2221 thereon. When the first supporting foot 121 vertically slips into the sliding slot 221 completely, there are grooves corresponding to the protrusions 1231 of the first supporting foot 121 on the sides of the sliding slot 221, and the projection 1241 arranged on the outer surface of the link arm 124 of the first supporting foot 121 resists against the inner end of the sliding slot 221, then the moving shift block 222 is pushed transversely, and the clasp 2221 of the moving shift block 222 is locked with the projection 1241 of the first supporting foot 121, so as to prevent the slipping of the first supporting foot 121 out of the sliding slot 221. When the first supporting foot 121 is desirable to be pulled out, the moving shift block 222 will be pushed transversely and outwardly, and the clasp 2221 of the moving shift block 222 will be disengaged from the projection 1241 of the first supporting foot 121, then only the first supporting foot 121 is pulled out outwardly.

In this embodiment, the above-mentioned bracket 100 is employed in a flat panel electronic product, and the flat panel electronic device 210 and the keyboard 220 are connected together when the first supporting foot 121 of the bracket 100 is fixed on the bottom of the keyboard 220. The first supporting foot 121 may be pulled out from the keyboard 220, then the bracket 100 is merely used for supporting the flat panel electronic device 210, then the keyboard 220 and the flat panel electronic device 210 may work separately, and the signal between the keyboard 220 and the flat panel electronic device 210 is transmitted by means of wireless mode. The above-mentioned bracket has the advantage of simple structure, flexible and convenient application.

Furthermore, in this embodiment, because the first supporting foot 121, the second supporting foot 122 and the supporting arm 111 moves around the pivot 130 separately, the angles among the first supporting foot 121, the second supporting foot 122 and the supporting arm 111 may be fixed at any value, and the supporting arm 111 and the connecting part 112 are connected via pivot, so the supporting arm 111 and the connecting part 112 may be fixed at any angle. The flat panel electronic device of a flat panel electronic product may rotate around the coupling of the connecting part 112, thus the bracket 100 may have different applications, and be used for many different occasions.

Referring to FIG. 5, the first supporting foot 121 of the bracket 100 are inserted into the bottom of a keyboard 220, as a result, the second supporting foot 122 rotates outwardly and play the role of supporting, and this is suitable for using a keyboard. Alternatively, the first supporting foot 121 of the bracket 100 and the keyboard 220 may be coupled with each other by means of magnetic connectors. And, in both cases, the flat panel electronic device 210 of a flat panel electronic product can rotate around the connecting part 112, and the flat panel electronic device 210 may be settled horizontally or vertically, alternatively, the flat panel electronic device may rotate around the connecting part 112 to fix the flat panel electronic device and the supporting arm 111 at any angle.

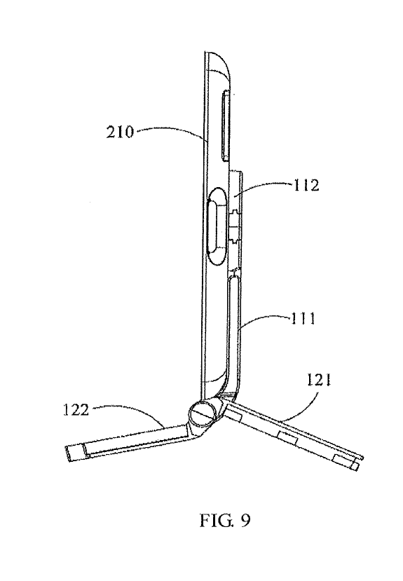

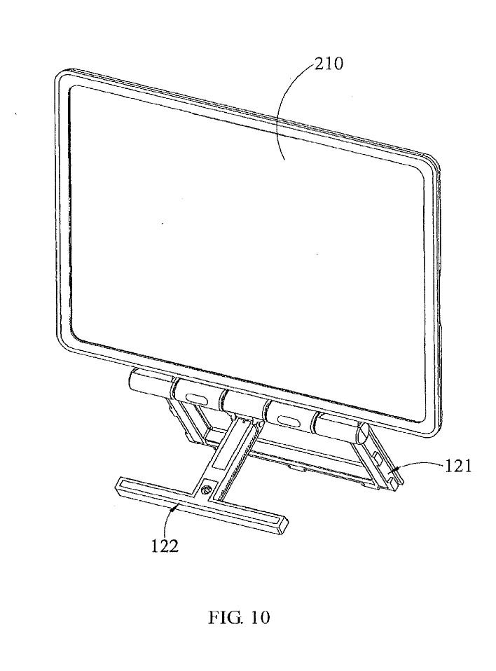

When the bracket 100 is detached from the keyboard 220, the bracket 100 is used as a separate bracket for supporting a flat panel electronic device. Particularly, referring to FIG. 8, the first supporting foot 121 is disposed on the rear and the second supporting foot 122 is on the front, the angle between them is 80°; obviously, the angle between them may be adjusted to less than 80° or over 80°, as shown in FIG. 9; and based on FIG. 8 and FIG. 9, the angle between the flat panel electronic device 210 and the connecting part 112 may be as shown in FIG. 10.

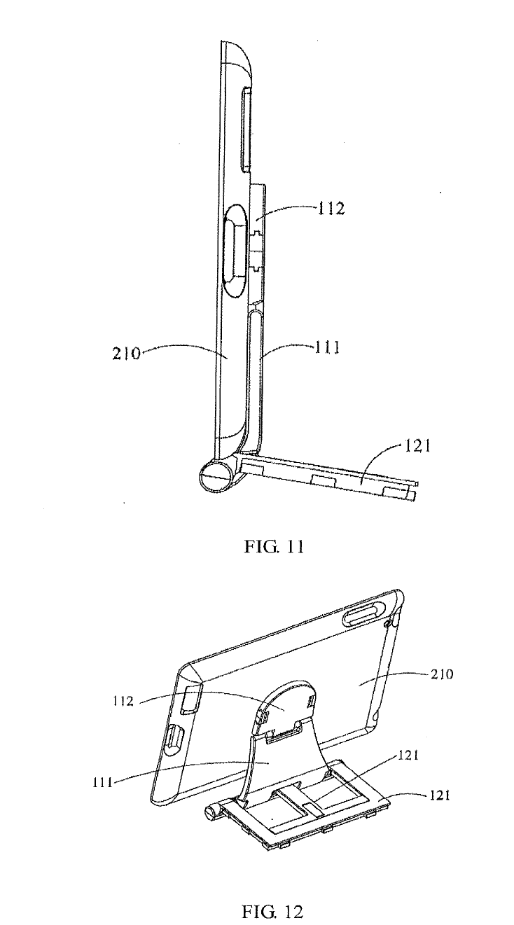

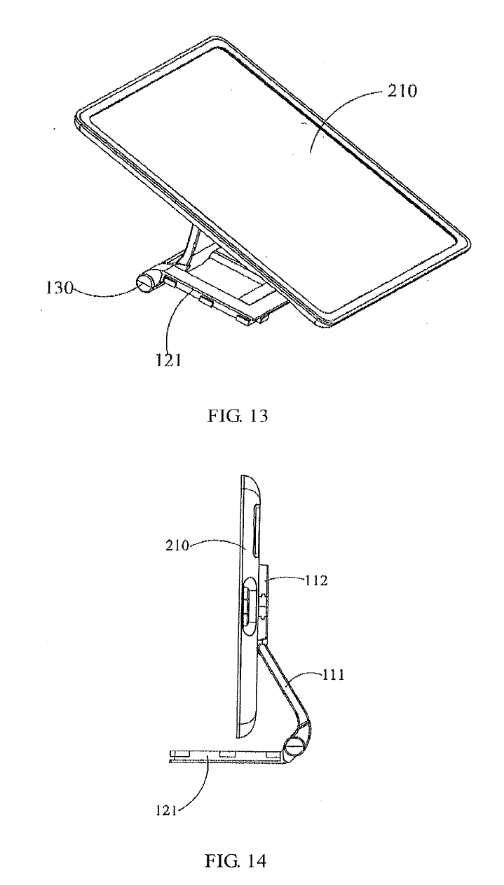

Referring to the FIG. 11 and FIG. 12, when the second supporting foot 122 is positioned inside the first supporting foot 121, they may also support the flat panel electronic device 210. At this time, both the first supporting foot 121 and the second supporting foot 122 move towards the rear of the pivot 130, as shown in FIG. 13. And the flat panel electronic device 210 may be arranged vertically after rotation, as shown in FIG. 14. Also, the angle between the supporting arm 111 and the supporting foot 120 may be adjusted, at the same time the flat panel electronic device 210 will be adjusted.

In summary, the bracket 100 according to the present invention may be adjusted to any required supporting angle, which is more convenient for use, and more user-friendly, and the bracket 100 may be free to fold after use and easy to carry. Also, the bracket 100 may be widely used in many kinds of vehicle equipments or other occasions and can be widely used.

The embodiments above are merely the preferable embodiments of the present invention and the structure thereof is not intended to be limited by the shapes above. And all changes, equivalent substitution and improvements which come within the meaning and range of equivalency of the present invention are intended to be embraced therein.

1. A bracket comprising a fixing plate suitable for connecting to a case enclosing a flat panel electronic device, a supporting foot suitable for being fixed to the bottom of a keyboard, and a pivot arranged between the fixing plate and the supporting leg and connected to them, the fixing plate and the supporting foot may rotate around the pivot separately.

2. The bracket of claim 1, wherein the supporting leg comprises a first supporting foot and a second supporting foot, the first supporting foot includes two rotating arms arranged in parallel and rotatably connected to the ends of the pivot separately and a link arm arranged between the two rotating arms and connected to them; the second supporting foot has the shape of inverted T, the vertical part thereof being rotatably connected to the middle part of the pivot, and the horizontal part of the second supporting foot being positioned inside the link arm following rotation.

3. The bracket of claim 2, wherein at least one projection is/are arranged at the outer surface of the link arm of the first supporting foot, the projection may be coupled with a keyboard.

4. The bracket of claim 2, wherein there are a number of spaced protrusions disposed at the outer surface of the rotating arms of the first supporting foot.

5. The bracket of claim 2, wherein there is a slot containing a movable press key in the vertical part of the second supporting foot, and a supporting shaft is arranged at the central part of the press key, the two ends of the supporting shaft are disposed in the slot, and the end thereof close to the pivot may be pressed down and the other end may go up.

6. The bracket of claim 1, wherein the fixing plate comprises a supporting arm and a connecting part rotatably coupled with the supporting arm, the supporting arm is rotatably coupled with the pivot, and there is a fastening on the connecting part for coupling with a case enclosing a flat panel electronic device and for the rotation thereof.

7. The bracket of claim 6, wherein the fastening contains a round groove and a pair of elastic clasps arranged therein, wherein the elastic clasps may move inwardly.

8. A flat panel electronic product comprising a flat panel electronic device and a keyboard, wherein the flat panel electronic product further comprises a bracket containing including a fixing plate suitable for connecting with a case enclosing the flat panel electronic device, a supporting leg suitable for being fixed to the bottom of the keyboard and a pivot arranged between the fixing plate and the supporting leg and connected to them, and the fixing plate and the supporting leg may rotate around the pivot separately.

9. The flat panel electronic product of claim 8, wherein the supporting leg comprises a first supporting foot and a second supporting foot, the first supporting foot includes two rotating arms arranged in parallel and rotatably connected to the ends of the pivot separately and a link arm arranged between the two rotating arms and connected to them; the second supporting foot has the shape of inverted T, the vertical part thereof being rotatably connected to the middle part of the pivot, the horizontal part thereof being positioned inside the link arm following rotation.

10. The flat panel electronic product of claim 9, wherein the bottom of the keyboard is provided with a sliding slot for the sliding of the first supporting foot, the link arm of the first supporting foot has at least one projection installed on the outer surface thereof, and the sliding slot is equipped with a moving shift block which has a clasp for locking the projection.

11. The bracket of claim 3, wherein there are a number of spaced protrusions disposed at the outer surface of the rotating arms of the first supporting foot.
